(19) United States
(12) Patent Application Publication
(10) Pub. No.: US 2024/0314545 A1
(43) Pub. Date: Sep. 19, 2024

(54) METHOD FOR WIRELESS COMMUNICATION, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Jinyu ZHANG, Dongguan (CN)

(21) Appl. No.: 18/669,856

(22) Filed: May 21, 2024

Related U.S. Application Data
(63) Continuation of application No. PCT/CN2021/132011, filed on Nov. 22, 2021.

(51) Int. Cl. H04W 8/24

(52) U.S. Cl. CPC H04W 8/24

(57) ABSTRACT

A method for wireless communication, a terminal device, and a network device are provided. The method includes the following. A terminal device sends a first message to a network device, where the first message is used for negotiation of a first capability of the terminal device, and the first capability is associated with a first rule. The terminal device determines an effect time or an expiry time of the first capability based on the first rule.

### CROSS-REFERENCE TO RELATED APPLICATION(S)

This application is a continuation of International Application No. PCT/CN2021/132011, filed Nov. 22, 2021, the entire disclosure of which is hereby incorporated by reference.

### TECHNICAL FIELD

This disclosure relates to the field of communication technology, and more particularly to a method for wireless communication, a terminal device, and a network device.

### RELATED ART

In some application scenarios, capabilities of terminal devices change dynamically. For example, in the scenario for a multi-card terminal device, hardware resources of the terminal device are shared by multiple communication cards of the terminal device. Sometimes one communication card can use almost all the hardware resources of the terminal device, and sometimes each communication card can only individually use part of the hardware resources of the terminal device, so that the capability of the terminal device changes dynamically.

In order to enable a network device to know the details of the dynamic change of the capability of the terminal device, the terminal device performs capability negotiation with the network device. However, when the negotiated capability takes effect or expires is an issue that needs to be addressed. If the terminal device and the network device do not agree on an understanding of an effect time or an expiry time of the capability of the terminal device, it may lead to communication efficiency degradation, e.g., the communication bit error rate (BER) is increased and an unnecessary data retransmission process is triggered.

### SUMMARY

The present disclosure provides a method for wireless communication, a terminal device, and a network device.

In a first aspect, a method for wireless communication is provided. The method includes that a terminal device sends a first message to a network device, where the first message is used for negotiation of a first capability of the terminal device, and the first capability is associated with a first rule; and the terminal device determines an effect time or an expiry time of the first capability based on the first rule.

In a second aspect, a terminal device is provided. The terminal device includes a transceiver, a processor coupled to the transceiver, and a memory storing a computer program which, when executed by the processor, causes the terminal device to send a first message to a network device, where the first message is used for negotiation of a first capability of the terminal device, and the first capability is associated with a first rule; to determine an effect time or an expiry time of the first capability based on the first rule.

In a third aspect, a network device is provided. The network device includes a transceiver, a processor coupled to the transceiver, and a memory storing a computer program which, when executed by the processor, causes the network device to receive a first message sent by a terminal device, where the first message is used for negotiation of a first capability of the terminal device, and the first capability is associated with a first rule; to determine an effect time or an expiry time of the first capability based on the first rule.

Other features and aspects of the disclosed features will become apparent from the following detailed description, taken in conjunction with the accompanying drawings, which illustrate, by way of example, the features in accordance with implementations the disclosure. The summary is not intended to limit the scope of any implementations described herein.

### BRIEF DESCRIPTION OF THE DRAWINGS

FIG. 1 is an example diagram of a wireless communication system to which embodiments of the present disclosure may be applied.

FIG. 2 is a schematic flow chart of a method for wireless communication provided by an embodiment of the present disclosure.

FIG. 3 is a schematic flow chart of a method for wireless communication provided by another embodiment of the present disclosure.

FIG. 4 is a schematic structural diagram of a terminal device provided by embodiments of the present disclosure.

FIG. 5 is a schematic structural diagram of a network device provided embodiments of the present disclosure.

FIG. 6 is a schematic structural diagram of an apparatus provided by embodiments of the present disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

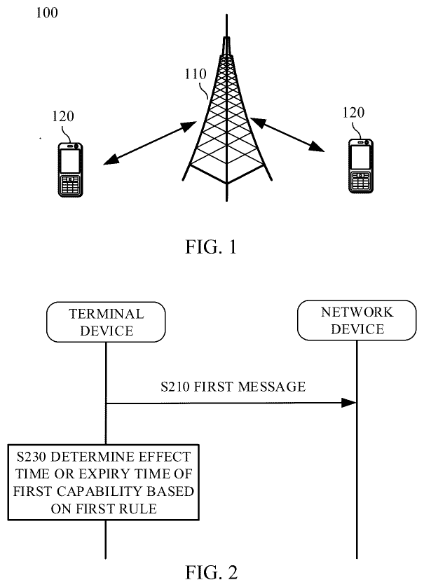

FIG. 1 is a wireless communication system 100 to which embodiments of the present disclosure are applied. The wireless communication system 100 may include a network device 110 and a terminal device 120. The network device 110 may be a device that can communicate with the terminal device 120. The network device 110 may provide communication coverage for a specific geographic area and may communicate with the terminal device 120 located in the coverage area.

FIG. 1 exemplarily illustrates one network device and two terminals. Optionally, the wireless communication system 100 may include multiple network devices, and other numbers of terminal devices may be included in the coverage area of each network device, which is not limited in the embodiments of the present disclosure.

Optionally, the wireless communication system 100 may further include other network entities such as a network controller, a mobility management entity, or the like, and embodiments of the disclosure are not limited in this regard.

It is understood that the technical solutions of the embodiments of the present disclosure are applicable to various communication systems, for example, the fifth generation (5G) systems or the new radio (NR) system, the long-term evolution (LTE) system, the LTE frequency division duplex (FDD) system, the LTE time division duplex (TDD) system, or the like. The technical solutions provided in the present disclosure can also be applicable to future communication systems, such as the sixth-generation mobile communication system, satellite communication systems, etc.

The terminal device in the embodiments of the present disclosure may also be referred to as a user equipment (UE), an access terminal, a user unit, a user station, a mobile platform, a mobile station (MS), a mobile terminal (MT), a remote station, a remote terminal, a mobile device, a user terminal, a terminal, a wireless communication device, a user agent, or a user device. The terminal device in the embodiments of the present disclosure may be a device that provides voice and/or data connectivity to a user and may be used to connect a person, an object, and a machine, such as a hand-held device with wireless connectivity, an in-vehicle device with wireless connectivity, and the like. The terminal device in the embodiments of the present disclosure may be a mobile phone, a Pad, a laptop computer, a handheld computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, and so on. Optionally, the UE may be used to act as a base station. For example, the UE may act as a scheduling entity that provides sidelink signals for UEs in vehicle-to-everything (V2X) or UEs in device-to-device (D2D), etc. For example, cellular phones and cars communicate with each other using sidelink signals. Cellular phones and smart home devices communicate with each other without relaying communication signals through a base station.

The network device in the embodiments of the present disclosure may be a device for communicating with the terminal device, and the network device may also be referred to as an access network device or a radio access network (RAN) device, e.g., the network device may be the base station. The network device in the embodiments of the present disclosure may refer to a RAN node (or device) that enables the terminal device to access a wireless network. The base station may broadly cover the following various names or may be substituted with the following names, for example, NodeB, evolved NodeB (eNB), next-generation NodeB (gNB), relay station, access point, transmitting and receiving point (TRP), transmitting point (TP), master station (MeNB), secondary station (SeNB), multi-standard radio (MSR) node, home base station, network controller, access node, wireless node, access point (AP), transmission node, transmitting and receiving node, base band unit (BBU), remote radio unit (RRU), active antenna unit (AAU), remote radio head (RRH), central unit (CU), distributed unit (DU), positioning node, and so on. The base station may be a macro base station, a micro base station, a relay node, a donor node, or the like, or a combination thereof. The base station may further refer to a communication module, a modem or a chip provided within the aforementioned equipment or device. The base station may further be a mobile switching center, a device that acts as a base station in D2D communication, a device that acts as a base station in V2X communication, a device that acts as a base station in machine-to-machine (M2M) communication, a network-side device in a 6G network, a device that acts a base station in a future communication system, or the like. The base station may support networks of the same or different access technologies. The specific technology and the specific device form used for the network device are not limited in the embodiments of the present disclosure.

The base station may be fixed or mobile. For example, a helicopter or a drone may act as a mobile base station, and one or more cells may be moved according to the location of the mobile base station. In other examples, the helicopter or the drone may be used as a device for communicating with another base station.

In some deployments, the network device in the embodiments of the present disclosure may refer to the CU or the DU. Alternatively, the network device includes the CU and the DU. The gNB may also include the AAU.

The network device and the terminal device may be deployed on land, which includes indoor or outdoor, handheld, or in-vehicle. The network device and the terminal device may also be deployed on water. The network device and the terminal device may also be deployed in the air (such as airplanes, balloons, satellites, etc.). The scenarios in which the network device and the terminal device are deployed are not limited in the embodiments of the present disclosure.

It is understood that all or some of the functionalities of the communication device of the present disclosure may also be implemented via software running on hardware, or via instantiated virtualization functionality on a platform (e.g., a cloud platform).

For the convenience of understanding, some related art involved in the embodiments of the present disclosure is first introduced. The following related art can be arbitrarily combined with the technical solutions of the embodiments of the present disclosure as optional solutions, and they all fall within the scope of protection of the embodiments of the present disclosure. The embodiments of the present disclosure include at least some of the following.

### 5G Application Scenarios

Considering people's pursuit of rate, latency, high-speed mobility, and energy efficiency, and considering the diversity and complexity of future services in life, the international standards organization of the 3rd generation partnership project (3GPP) has begun to develop 5G. Main application scenarios in 5G are enhanced mobile broadband (eMBB), ultra-reliable low latency communication (URLLC), and massive machine type communication (mMTC).

On the one hand, eMBB still aims for users to access multimedia content, services, and data. The demand for eMBB is growing rapidly. On the other hand, since eMBB may be deployed in different scenarios, e.g., indoors, urban areas, rural areas, etc., and capabilities of eMBB and requirements for eMBB vary considerably in different scenarios, the analysis on eMBB should not be generalized and needs to be made in detail with specific deployment scenarios.

A key feature of URLLC is low latency, where a connection latency can be 1 ms or less in this scenario, and URLLC supports highly reliable connectivity in high-speed movement, for example, reliability of URLLC can reach 99.999%in the case where the movement speed reaches 500 km/h. Typical applications of URLLC include industrial automation, power automation, telemedicine operations (surgery), traffic safety assurance, etc.

Typical features of mMTC include high connection density, small data volume, latency-insensitive services, and low cost and long service life of modules. Based on this, mMTC can include one or more of the following communications: communication for industrial wireless sensor networks, communication in video surveillance scenarios, and communication for wearable devices.

### Radio Resource Control (RRC) State

In order to reduce air interface signalling, and quickly restore wireless connections and data services, 5G defines a new RRC state, i.e., an RRC inactive (RRC_INACTIVE) state. The RRC_INACTIVE state is different from an RRC idle (RRC_IDLE) state and an RRC connected (RRC_CONNECTED) state.

(1) RRC_IDLE state (referred to as an idle state): Cell selection/reselection of the terminal device is based on mobility. Paging is initiated by a core network (CN). A paging area is configured by the CN. There is no terminal device access stratum (AS) context at the network device side. No RRC connection exists.

(2) RRC_CONNECTED state (referred to as a connected state): An RRC connection exists. A terminal device AS context exists at the network device side and the terminal device side. The network side knows the location of the terminal device based on a specific cell level. Mobility is controlled by the network device side. Unicast data can be transmitted between the terminal device and the network device.

(3) RRC_INACTIVE state (referred to as an inactive state): Cell selection/reselection of the terminal device is based on mobility. A connection exists between the CN and a radio access network (RAN). A terminal device AS context exists in an anchor network device. Paging is triggered by the RAN, and an RAN-based paging area is managed by the RAN. The network side knows the location of the terminal device based on the RAN-based paging area level.

### Multi-Card Terminal

In a digital cellular mobile communication system, the terminal device may operate in a machine-card-separated operating mode. In other words, the terminal device may be consisted of a mobile equipment (ME) and a communication card.

Terminal devices can be classified into single-card terminal devices and multi-card terminal devices according to the number of communication cards supported by the terminal devices. With the development of communication technology, a large number of multi-card terminal devices (e.g., mobile phones, wearable devices, etc.) are in the communication network. A multi-card terminal device can support multiple communication cards.

The most common multi-card terminal device is a dual-card terminal device. The following is a detailed illustration of the multi-card terminal device taking the dual-card terminal device as an example.

The dual-card terminal device can support two communication cards. In some embodiments, the dual-card terminal device may be a dual-card-dual-standby terminal device. The dual-card-dual-standby terminal device refers to a terminal device that can support two communication cards at the same time, and both communication cards are in a standby state. The dual-card-dual-standby terminal device generally refers to a terminal device having a dual-card-dual-standby mode in the same network system, such as a dual-card-dual-standby mode in the global system for mobile communication (GSM) network, a dual-card dual-standby mode in the code division multiple access (CDMA) network, and a dual-card-dual-standby mode in the personal handy-phone system (PHS), etc. In some embodiments, the dual-card terminal device may be a dual-network-dual-standby terminal device. The dual-network-dual-standby terminal device refers to a terminal device that can support two communication cards of different networks and keep the two communication cards awake at the same time, so that the user can make and receive calls or to send and receive text messages without network switching.

At present, most of the terminal devices only support single-transmit single-receive (or referred to as single UL/DL) or single-transmit dual-receive (or referred to as single UL/dual DL), which means that the terminal device can deal with services of merely one communication card at a moment. The terminal device generally does not support pure dual-transmit dual-receive (which can be referred to as dual active or dual UL/DL), i.e., the terminal device cannot simultaneously perform uplink data transmission and downlink data reception on two networks via two communication cards. The multi-card terminal device that supports dual active needs to have at least two transmit antennas and at least two receive antennas, and this type of terminal device allows both communication cards to be in the connected state at the same time.

However, realizing dual active is a trend in the future development of terminal devices. In 5G, for the terminal device that supports dual-card dual-standby or dual-network dual-standby, one of two communication cards of the terminal device can reside in an LTE cell and the other in an NR cell, or the two communication cards can both reside in the NR cell. On the other hand, the two communication cards may be communication cards of the same operator or different operators.

It is noted that the concept of the multi-card terminal device having more than two communication cards has a similar logic to the dual-card terminal device described above, which will not be repeated here.

It is noted that the type of communication card is not limited in embodiments of the present disclosure. In some embodiments, the communication card may refer to a subscriber identity module (SIM) card. In some embodiments, the communication card may refer to a universal subscriber identity module (USIM) card which may also be referred to as an upgraded SIM card.

It is noted that in the case where the terminal device is the multi-card terminal device, the types of multiple communication cards may be the same or different. For example, the multiple communication cards may all be SIM cards, or the multiple communication cards may all be USIM cards, or for example, some of the multiple communication cards may be SIM cards and the others may be USIM cards.

In some application scenarios, capabilities of terminal devices change dynamically. The dynamic change of the capability of the terminal device is briefly introduced in combination with two examples as follows.

In an example, in the scenario for the multi-card terminal device, hardware resources of the terminal device are shared by multiple communication cards of the terminal device, and sometimes one communication card can use almost all the hardware resources of the terminal device, and sometimes each communication card can only individually use part of the hardware resources of the terminal device. Take the dual-card terminal device as an example, the dual-card terminal device can have two communication cards e.g. communication card A and communication card B. In the case where communication card A is in the connected state and communication card B is in the idle state or in the inactive state, communication card A can use almost all hardware resources of the terminal device; whereas, in the case where communication card A and communication card B are both in the connected state, communication card A and communication card B can only respectively use part of the hardware resources of the terminal device. In other words, hardware-resource sharing details of the multi-card terminal device will change dynamically with the application state of each communication card.

In another example, in the scenario for a single-card terminal device, under certain circumstances (e.g., the terminal device receives and sends data for an excessively long period of time resulting in heating of the terminal device), the terminal device may temporarily degrade its communication capability via capability negotiation to receive and send data, so as to protect the terminal device from being damaged by overheating. For example, the maximum number of receive antennas supported by the terminal device and the maximum number of transmit antennas supported by the terminal device are both four. After the terminal device has used four receive antennas to receive data and four transmit antennas to send data for a period of time, the terminal device senses that the terminal device itself heats up to a relatively high degree, so that the terminal device may send a temporary-capability negotiation request message to the network device, requesting to use two receive antennas to receive data and two transmit antennas to send data. In this case, the change in the number of antennas used by the terminal device to receive and send data is the dynamic change in the capability of the terminal device.

In the foregoing application scenarios, in order to enable the network device to know the details of the dynamic change of the capability of the terminal device, the terminal device performs capability negotiation with the network device. In some embodiments, the case that the terminal device performs capability negotiation with the network device means that the terminal device and the network device negotiate a temporary capability that needs to take effect, for example, the terminal device negotiates with the network device to temporarily receive and send data with a relatively weak capability of the terminal device. In some embodiments, the case that the terminal device performs capability negotiation with the network device means that the terminal device negotiates with the network device to cancel the temporary capability that is in effect (or the terminal device negotiates with the network device to deactivate the temporary capability that is in effect), e.g., the terminal device can negotiate with the network device to cancel the temporary capability that is in effect, or the terminal device can negotiate with the network device to restore to the initial capability of the terminal device used before the temporary-capability negotiation.

In the following, take that the terminal device and the network device negotiate the number of transmit antennas of the terminal device and the number of receive antennas of the terminal device via the temporary-capability negotiation as an example for illustration.

A multi-card terminal device has card A and card B. The maximum number of receive antennas supported by the multi-card terminal device and the maximum number of transmit antennas supported by the multi-card terminal device are both two. Initially, card A is in the connected state, card B is in the idle state or the inactive state, and card A uses two transmit antennas to send data and use two receive antennas to receive data. At a first time, card B needs to enter the connected state and needs to “take away” one transmit antenna and one receiver antenna from card A. In order to let the network device perceive that the antenna capability of card A decreases (i.e., the number of transmit antennas for sending data decreases from two to one, and the number of receive antennas for receiving data decreases from two to one), the terminal device can perform temporary-capability negotiation with the network device via card A to make the network device understand that the capability of the terminal device needs to be temporarily changed from the capability of using two transmit antennas and two receive antennas to the capability of using one transmit antenna and one receiver antenna. At a second time, card B returns to the idle state or the inactive state, and the resources of one transmit antenna and one receiver antenna used by card B are released. In order to increase the throughput of card A, the terminal device can perform capability-restoration negotiation with the network device via card A to make the network device understand that the capability of the terminal device needs to restore from the capability of using one transmit antenna and one receiver antenna to the capability of using two transmit antennas and two receive antennas, i.e., card A can be used to perform capability negotiation to cancel the temporary capability that was previously determined via negotiation and is in effect, or card A can be used to perform capability negotiation to make the network device understand that the capability of the terminal device needs to restore to the capability that was used by the terminal device before temporary-capability negotiation, or card A can be used to perform capability negotiation to make the network device understand that the capability of the terminal device needs to restore to factory settings.

For another example, the maximum number of receive antennas supported by the terminal device and the maximum number of transmit antennas supported by the terminal device are both four. After the terminal device has used four receive antennas to receive data and four transmit antennas to send data for a period of time, the terminal device heats up to a relatively high degree, so that the terminal device may perform capability negotiation with the network device to request using two receive antennas to receive data and two transmit antennas to send data, i.e., the terminal device and the network device can negotiate the temporary capability that needs to take effect (the capability of using two receive antennas to receive data and using two transmit antennas to send data). After the terminal device has used two receive antennas to receive data and used two transmit antennas to send data for a period of time, if the terminal device wants to restore to the capability of using four receive antennas to receive data and using four transmit antennas to send data, the terminal device can perform capability negotiation with the network device again to request cancelling the capability of using two receive antennas to receive data and using two transmit antennas to send data and request restoring to the capability of using four receive antennas receive data and using four transmit antennas send data, i.e., the terminal device can negotiate with the network device to cancel the temporary capability that is in effect (after cancellation, the terminal device restores to the capability that was used by the terminal device before the temporary-capability negotiation to send and receive data).

In some embodiments, the case that the terminal device negotiates with the network device to cancel the temporary capability that is in effect may also be considered as that the terminal device and the network device negotiate another capability that needs to be in effect. Exemplarily, the case that the terminal device negotiates with the network device to cancel the capability that is in effect, i.e., the capability of using two receive antennas to receive data and using two transmit antennas to send data, may be considered to be that the terminal device negotiates with the network device to enable a new capability, i.e., the capability of using four receive antennas to receive data and using four transmit antennas to send data, to take effect.

It is noted that specific information of the capability negotiated by the terminal device and the network device is not limited in the embodiments of the present disclosure. Exemplarily, the specific information of the capability negotiated may include at least one of: the number of transmit antennas of the terminal device, the number of receive antennas of the terminal device, a maximum number of carriers supported by the terminal device, a maximum bandwidth supported by the terminal device, a dual-connectivity (DC) capability of the terminal device, a carrier aggregation (CA) capability of the terminal device, a maximum number of multiple input multiple output layers supported by the terminal device, or the maximum transmit power supported by the terminal device.

In some embodiments, in the case where the terminal device performs capability negotiation with the network device, one or more capabilities of the terminal device can be negotiated. For example, the terminal device and the network device may only negotiate the number of receive antennas of the terminal device, or the terminal device and the network device may negotiate the number of receive antennas of the terminal device, the maximum transmit power of the terminal device and the like.

In some embodiments, capability negotiation between the terminal device and the network device may have different results, which are not limited in the present disclosure. In an example, the capability(ies) requested by the terminal device may all be accepted by the network device, for example, the terminal device requests one capability, and the result of the capability negotiation may be that the network device agrees with the terminal device to use the capability to send and receive data; alternatively, the terminal device requests for multiple capabilities, and the result of the capability negotiation may be that the network device agrees with the terminal device to use the multiple capabilities to send and receive data. In another example, some of the capabilities requested by the terminal device may be accepted by the network device. For example, the terminal device requests three capabilities (the number of transmit antennas of the terminal device, the number of receive antennas of the terminal device, and the maximum transmit power supported by the terminal device). In this case, the network device may only agree with the terminal device to use the capability of the number of transmit antennas of the terminal device and the capability of the number of receive antennas of the terminal device requested by the terminal device. For the capability of the maximum transmit power requested by the terminal device, the network device may not agree with the terminal device to use the maximum transmit power requested by the terminal device, and may further negotiate with the terminal device on the maximum transmit power that can be adopted by the terminal device.

As mentioned above, in the case where the terminal device and the network device negotiate the temporary capability that needs to take effect, the terminal device and the network device need to configure the effect time of the negotiated temporary capability. For example, in the case where the terminal device determines to use two receive antennas to receive data and two transmit antennas to send data via negotiation with the network device, the terminal device and the network device need to configure a time at which the terminal device starts to use two receive antennas to receive data and use two transmit antennas to send data. Alternatively, in the case where the terminal device determines to cancel the temporary capability that is in effect via negotiation with the network device, the terminal device and the network device need to configure the expiry time of the temporary capability. For example, in the case where the terminal device determines via negotiation with the network device to cancel the capability that is in effect, i.e., the capability of using two receive antennas to receive data and using two transmit antennas to send data, the terminal device and the network device need to configure a time at which the terminal device cancels the capability of using two receive antennas to receive data and using two transmit antennas to send data, in other words, the terminal device and the network device need to configure a time at which the terminal device reuses the capability that was used by the terminal device before capability negotiation, i.e., the capability of using four receive antennas to receive data and four transmit antennas to send data. However, how to determine the effect time and the expiry time of the negotiated capability is a problem needed to be addressed. If the terminal device and the network device do not agree on an understanding of the effect time and the expiry time of the capability of the terminal device, it may lead to communication efficiency degradation, e.g., the communication bit error rate (BER) is increased and an unnecessary data retransmission process is triggered.

In order to resolve the foregoing issues, embodiments of the present disclosure are illustrated in detail as follows.

FIG. 2 is a schematic flow chart of a method for wireless communication provided by embodiments of the present disclosure. The method illustrated in FIG. 2 is described from the perspective of interaction between a terminal device and a network device. The terminal device and the network device may be the terminal device and the network device illustrated in FIG. 1. The method illustrated in FIG. 2 includes an operation at S210 and an operation at S230, which are described in detail as follows.

At S210, the terminal device sends a first message to the network device. The first message is used for negotiation of a first capability of the terminal device. The first capability is associated with a first rule.

Optionally, the first message is any one of an RRC message, a radio link control (RLC) protocol data unit (PDU) message (referred to as an RLC PDU message), a medium access control (MAC) control element (CE) message (referred to as a MAC CE message), and an uplink control information (UCI) message.

Optionally, the first message may be used to negotiate a temporary capability (e.g., the number of transmit antennas for sending data decreases from two to one, and the number of receiver antennas for receiving data decreases from two to one), or the first message may be used to cancel the temporary capability that was determined via negotiation (e.g., after capability negotiation, the capability is restored to the capability of using two transmit antennas to send data and using two receive antennas to receive data from the capability of using one transmit antennas to send data and using one receive antennas to receive data).

In some embodiments, the first capability may refer to all capabilities requested by the terminal device. Exemplarily, in the case where one or more capabilities are requested by the terminal device and the result of the negotiation between the terminal device and the network device is that the network device agrees with the terminal device to use all the capabilities requested by the terminal device to send and receive data, the first capability includes all the capabilities requested by the terminal device.

In some embodiments, the first capability may refer to some of the capabilities requested by the terminal device, which means that the network device agrees with the terminal device to adopt some of the capabilities requested by the terminal device. Exemplarily, in the case where the terminal device requests multiple capabilities and the result of the negotiation between the terminal device and the network device is that the network device agrees with the terminal device to adopt some (one or more) of the capabilities requested by the terminal device to send and receive data, the first capability is the capability that the network device agrees with the terminal device to adopt.

In an example, the first rule may be a rule of effect. For example, in the case where that the terminal device and the network device perform capability negotiation refers to that the terminal device and the network device negotiate a temporary capability that needs to take effect, the first rule indicates an effect time of the first capability. In another example, the first rule may be a rule of expiry. For example, in the case where that the terminal device and the network device perform capability negotiation refers to that the terminal device negotiates with the network device to cancel the temporary capability that is in effect, the first rule indicates an expiry time of the first capability.

The first rule may be pre-configured or predefined in a protocol, or the first rule may be explicitly configured via signalling. The specifics of the first rule will be illustrated in detail in the following and are not repeated here.

At S230, the terminal device determines the effect time or the expiry time of the first capability based on the first rule.

In some embodiments, the effect time of the first capability may refer to a time at which the first capability takes effect, or the expiry time of the first capability may refer to a time at which the first capability expires. The unit of the effect time or the expiry time may be frame, slot, sub-frame, symbol, second, or millisecond, etc., which is not limited in the present disclosure. Exemplarily, the first capability may take effect in the 5th slot (slot 5), or the first capability may expire at 2021 Nov. 18 16:00:00.

In the embodiments of the present disclosure, the terminal device is required to determine the effect time or the expiry time of the negotiated first capability based on the first rule during capability negotiation with the network device, so that the terminal device and the network device have the consistent understanding of the effect time or the expiry time of the first capability, thereby mitigating as much as possible the problem of communication efficiency degradation generated due to the inconsistency between understanding of the capability of the terminal device by the terminal device and understanding of the capability of the terminal device by the network device.

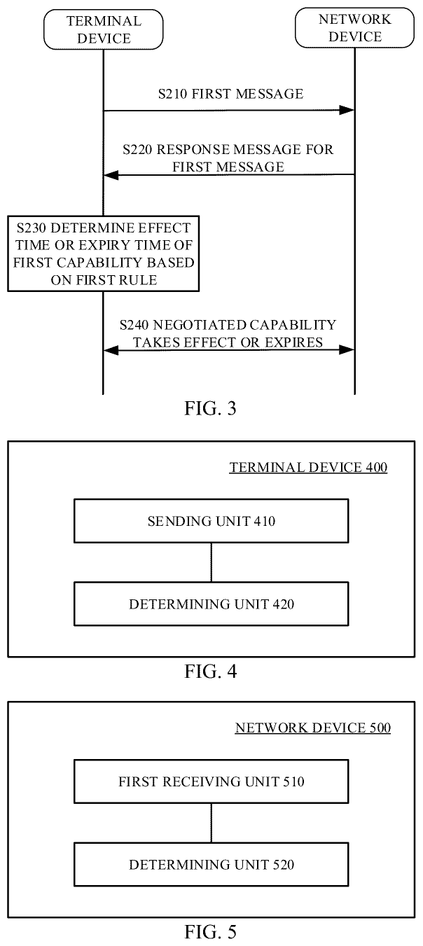

FIG. 3 is a schematic flow chart of another method for wireless communication provided by embodiments of the present disclosure. In the embodiment illustrated in FIG. 3, the method further includes an operation at S220.

At S220, the network device sends a response message for the first message to the terminal device.

Specifically, after the terminal device sends the first message to the network device, the network device may send the response message for the first message to the terminal device.

The response message for the first message may indicate a confirmation result of capability negotiation. In an example, the response message for the first message may indicate that the network device agrees with the terminal device to adopt all the capabilities requested by the terminal device to send and receive data, e.g., the response message for the first message may indicate a positive confirmation via 1 bit. In another example, the response message for the first message may indicate that the network device agrees with the terminal device to adopt some of the capabilities requested by the terminal device to send and receive data, e.g., the response message for the first message may indicate, via a form that is the same as the form of the first message, a confirmation of the negotiation result of each of the capabilities requested by the terminal device.

The message type of the response message for the first message is not limited in embodiments of the present disclosure. Exemplarily, the response message for the first message may be any one of an RRC message, an RLC PDU message, a MAC CE message, and a downlink control information (DCI) message.

Reference is still made to FIG. 3, in the embodiment illustrated in FIG. 3, the method of the present disclosure may further include an operation at S240.

At S240, a capability negotiated by the terminal device and the network device takes effect or expires. Specifically, the negotiated capability takes effect at the effect time of the first capability or expires at the expiry time of the first capability.

The first rule and the effect time corresponding to the first rule are illustrated in detail as follows, or the first rule and the expiry time corresponding to the first rule are illustrated in detail as follows.

In some embodiments, the first rule indicates that the first capability comes into effect after a first delay that starts from a first time or expires after the first delay.

In an example, for the terminal device, the first time may be determined based on a time at which the terminal device receives the response message for the first message, and for the network device, the first time may be determined based on a time at which the network device sends the response message for the first message.

In the case where the first time is determined based on the time at which the terminal device receives the response message for the first message, the first time may be a time corresponding to a time domain resource bearing the response message for the first message, e.g., the first time may be a time corresponding to the last time domain resource bearing the response message for the first message. In some embodiments, the time domain resource may be a frame, a sub-frame, a slot, or a symbol. Exemplarily, the first time may be a time corresponding to the last slot bearing the response message for the first message, the first time may be a time corresponding to the last sub-frame bearing the response message for the first message, or the first time may be a time corresponding to the last symbol bearing the response message for the first message.

Similarly, in the case where the first time is determined based on the time at which the network device sends the response message for the first message, the first time may be the time corresponding to the time domain resource bearing the response message for the first message, e.g., the first time may be a time corresponding to a first time domain resource bearing the response message for the first message. Exemplarily, the first time may be a time corresponding to the first slot bearing the response message for the first message, the first time may be a time corresponding to the first sub-frame bearing the response message for the first message, or the first time may be a time corresponding to the first symbol bearing the response message for the first message.

In another example, for the terminal device, the first time may be determined based on a time at which the terminal device sends the first message, and for the network device, the first time may be determined based on a time at which the network device receives the first message.

For example, for the terminal device, in the case where the terminal device does not receive, within a preset duration after the first message is sent, the response message for the first message sent by the network device, the first time may be determined based on the preset duration, and for the network device, if the network device does not send, within the preset duration after the network device receives the first message, the response message for the first message to the terminal device, the first time may be determined based on the preset duration.

In the case where the first time is determined based on the preset duration, in an example, the first time may be the time corresponding to the time domain resource of the preset duration, e.g., the first time may be a time corresponding to the last slot of the preset duration, the first time may be a time corresponding to the last sub-frame of the preset duration, or the first time may be a time corresponding to the last symbol of the preset duration. In another example, the first time may be a time corresponding to the first time domain resource after an end of the preset duration, e.g., the first time may be a time corresponding to the first slot after the end of the preset duration, the first time may be a time corresponding to the first sub-frame after the end of the preset duration, or the first time may be a time corresponding to the first symbol after the end of the preset duration.

In an implementation, the preset duration may correspond to a configuration of a timer. Specifically, the timer is started at a time at which the terminal device sends the first message to the network device, and if the terminal device receives the response message for the first message sent by the network device before the timer is timed out, the terminal device may determine the effect time or the expiry time of the first capability according to the time at which the terminal device receives the response message for the first message, so that the terminal device can use the negotiated first capability of the terminal device according to the effect time or the expiry time of the first capability, or the terminal device can use the negotiated first capability of the terminal device according to an effect time or an expiry time in the response message for the first message (the case that the response message for the first message can be configured to contain the effect time or the expiry time of the first capability will be illustrated in detail in the following and is not repeated here). Otherwise, if the terminal device does not receive the response message for the first message sent by the network device until the timer is timed out, the first time may be a time corresponding to the last slot before the timer is timed out, the first time may be a time corresponding to the last sub-frame before the timer is timed out, or the first time may be a time corresponding to the last symbol before the timer is timed out; or the first time may be a time corresponding to the first slot after the timer is timed out, the first time may be a time corresponding to the first sub-frame after the timer is timed out, or the first time may be a time corresponding to the first symbol after the timer is timed out.

The manner in which the preset duration is configured is not limited in embodiments of the present disclosure. In some embodiments, the preset duration may be configured via pre-configuration, for example, the preset duration may be predefined in the protocol. In some embodiments, the preset duration may be configured via a system broadcast message. In some embodiments, the preset duration may be configured via dedicated signalling, e.g., the network device configures the preset duration for the terminal device via an RRC message.

The type of the first delay is not limited in embodiments of the present disclosure. Exemplarily, the first delay may include at least one of an RRC message process delay, a fixed delay, or a capability switch delay of the terminal device.

In the present disclosure, for determination of the effect time or the expiry time of the first capability, a communication delay between the terminal device and the network device and the capability switch delay of the terminal device are fully considered, so as to avoid that the terminal device has not completed capability switch at the time at which the first capability takes effect.

As illustrated in the foregoing section, in the case where the network device determines the effect time or the expiry time of the first capability according to the first time and the first delay, the first time of the network device is the time at which the network device sends the response message for the first message. In the case where the terminal device communicates with the network device, there may be a communication delay if the terminal device is far away from the network device, and thus there may be a time difference between the time at which the network device sends the response message for the first message and the time at which the terminal device receives the response message for the first message. Therefore, for determination of the effect time or the expiry time of the first capability by the network device, the first delay may include a transmission delay or a round-trip time (RTT), and optionally, the first delay may include one-half of the RTT in the case where the RTT is considered for determination of the first delay.

In an example, in the case where the terminal device and the network device are far apart (for example, the network device is a satellite and the terminal device is a mobile phone deployed on land) and in communication, after the network device sends the response message for the first message, the terminal device can receive the response message for the first message after a certain transmission delay, where the transmission delay can up to a few milliseconds or tens of milliseconds. In this case, the network device considers the transmission delay between the network device and the terminal device for determination of the effect time or the expiry time of the first capability, so that it can be further ensured that the terminal device and the network device have consistent understanding of the effect time or the expiry time of the first capability, thereby mitigating as much as possible the problem of communication efficiency degradation generated due to the inconsistency between understanding of the capability of the terminal device by the terminal device and understanding of the capability of the terminal device by the network device. In another example, if the transmission delay between the network device and the terminal device is relatively small, for example, if the network device is a base station deployed on land and the terminal device is a mobile phone deployed on land, the transmission delay may be negligible.

The type of the first delay may be configured at a variety of granularities, which is not limited in embodiments of the present disclosure. Exemplarily, at least one delay included in the first delay may be configured at any one of: a frequency range (FR) granularity, a sub-carrier spacing (SCS) granularity, a combination of the FR granularity and the SCS granularity, and a fixed constant. The granularity used for the configuration of the first delay is illustrated below in combination with several specific examples.

### (1) FR Granularity

The first delay may be configured at the FR granularity. Delay values of the first delay can be defined respectively for different FRs. In other words, different types of first delays can be configured with different delay values for the same FR, or each type of first delay can be configured with different delay values for different FRs. Taking Table 1 as an example, the following illustrates that the first delay is configured at the FR granularity.

TABLE 1

| | FR1 | FR2-1 | FR2-2 |
|---|---|---|---|
| RRC message | delay constant 1 | delay constant 4 | delay constant 7 |
| process delay | | | |
| fixed delay | delay constant 2 | delay constant 5 | delay constant 8 |
| capability | delay constant 3 | delay constant 6 | delay constant 9 |
| switch delay | | | |

In Table 1, that the FR is classified into three types (FR1, FR2-1, and FR2-2) and the first delay includes three types of delay (the RRC message process delay, the fixed delay, and the capability switch delay) is taken as an example for illustration. Different types of first delays have different delay values in FRI, e.g., the delay value of the RRC message process delay is delay constant 1, the delay value of the fixed delay is delay constant 2, and the delay value of the capability switch delay is delay constant 3.

The RRC message process delay has different delay values for different FRs, e.g., the delay value of the RRC message process delay is delay constant 1 in FR1, the delay value of the RRC message process delay is delay constant 4 in FR2-1, and the delay value of the RRC message process delay is delay constant 7 in FR2-2.

The other types of first delays are associated with FRs in a manner similar to the illustration above, which will not be repeated here.

### (2) SCS Granularity

The first delay may be configured at the SCS granularity. The delay values of the first delay can be defined respectively for different SCSs. In other words, different types of first delays can be configured with different delay values for the same SCS, or each type of first delay can be configured with different delay values for different SCSs. Taking Table 2 as an example, the following illustrates that the first delay is configured at the SCS granularity.

TABLE 1

| | SCS1 | SCS2 | SCS3 |
|---|---|---|---|
| RRC message | delay constant 1 | delay constant 4 | delay constant 7 |
| process delay | | | |
| fixed delay | delay constant 2 | delay constant 5 | delay constant 8 |
| capability | delay constant 3 | delay constant 6 | delay constant 9 |
| switch delay | | | |

In Table 2, that the SCS is classified into three types (SCS1, SCS2, and SCS3) and the first delay includes three types of delay (the RRC message process delay, the fixed delay, and the capability switch delay) is taken as an example for illustration. Different types of first delays have different delay values for SCS1, e.g., the delay value of the RRC message process delay is delay constant 1, the delay value of the fixed delay is delay constant 2, and the delay value of the capability switch delay is delay constant 3.

The RRC message process delay has different delay values for different SCSs, e.g., the delay value of the RRC message process delay is delay constant 1 for SCS1, the delay value of the RRC message process delay is delay constant 4 for SCS2, and the delay value of the RRC message process delay is delay constant 7 for SCS3.

The value of SCS is not limited in the present disclosure. Exemplarily, the value of SCS may be 15 kHz, 30 kHz, 60 kHz, 120 kHz, 240 kHz, 480 kHz, 960 kHz, etc.

The other types of first delays are associated with SCSs in the manner similar to the illustration above, which will not be repeated here.

### (3) A Combination of the FR Granularity and the SCS Granularity

The first delay may be configured at the combination of the FR granularity and the SCS granularity. The delay values of the first delay can be defined respectively for different combinations of FR and SCS. In other words, different types of first delays can be configured with different delay values for the same combination of FR and SCS, or each type of first delay can be configured with different delay values for different combinations of the FR and the SCS. Taking Table 3 as an example, the following illustrates that the first delay is configured at the combination of the FR granularity and the SCS granularity.

TABLE 3

| | FR1 | | FR2-1 | | FR2-2 | |
|---|---|---|---|---|---|---|
| | SCS1 | SCS2 | SCS3 | SCS4 | SCS5 | SCS6 |
| RRC message | delay | delay | delay | delay | delay | delay |
| process delay | constant | constant | constant | constant | constant | constant |
| | 1-1 | 2-1 | 3-1 | 4-1 | 5-1 | 6-1 |
| fixed delay | delay | delay | delay | delay | delay | delay |
| | constant | constant | constant | constant | constant | constant |
| | 1-2 | 2-2 | 3-2 | 4-2 | 5-2 | 6-2 |
| capability | delay | delay | delay | delay | delay | delay |
| switch delay | constant | constant | constant | constant | constant | constant |
| | 1-3 | 2-3 | 3-3 | 4-3 | 5-3 | 6-3 |

In Table 3, that the FR is classified into three types and each type of the FR is associated with two types of SCS is taken as an example for illustration. In the case where the frequency range is FRI and the sub-carrier spacing is SCS1, different types of first delays have different delay values, e.g., the delay value of the RRC message process delay is delay constant 1-1, the delay value of the fixed delay is delay constant 1-2, and the delay value of the capability switch delay is delay constant 1-3.

The delay value of the RRC message process delay is delay constant 1-1 for the combination of FRI and SCS1. The delay value of the RRC message process delay is delay constant 2-1 for the combination of FRI and SCS2. The delay value of the RRC message process delay is delay constant 3-1 for the combination of FR2-1 and SCS3. The delay value of the RRC message process delay is delay constant 4-1 for the combination of FR2-1 and SCS4. The delay value of the RRC message process delay is delay constant 5-1 for the combination of FR2-2 and SCS5. The delay value of the RRC message process delay is delay constant 6-1 for the combination of FR2-2 and SCS6.

The other types of first delays are associated with combinations of FR and SCS in the manner similar to the illustration above, which will not be repeated here.

### (4) Fixed Constant

The delay value of the first delay may be configured at the fixed constant. In other words, each type of first delay has the same delay value in any scenario. In some embodiments, the delay value may be a fixed value. Taking Table 4 as an example, the following illustrates that the delay value of the first delay is configured at a fixed constant.

TABLE 4

| | any scenario |
|---|---|
| RRC message process delay | fixed constant 1 |
| fixed delay | fixed constant 2 |
| capability switch delay | fixed constant 3 |

As can be seen from the example of Table 4, in the case where the first delay is the RRC message process delay, the delay value of the first delay is fixed constant 1 in any scenario; in the case where the first delay is the fixed delay, the delay value of the first delay is fixed constant 2 in any scenario; in the case where the first delay is the capability switch delay, the delay value of the first delay is fixed constant 3 in any scenario.

It is noted that the first delay may include at least one of: the RRC message process delay, the fixed delay, and the capability switch delay of the terminal device, but each delay in the first delay can be separately configured or defined. In other words, in the case where the first delay includes multiple types of delays, the multiple types of delays may be configured at the same granularity or respectively configured at different granularities.

In an example, the first delay includes three types of delays: the RRC message process delay, the fixed delay, and the capability switch delay of the terminal device. The three types of delays may be configured at the same granularity, e.g., the three types of delays may be configured at the FR granularity. Alternatively, the three delays may be configured at different granularities, e.g., the RRC message process delay may be configured at the FR granularity, the fixed delay may be configured to be that the fixed delay is a fixed constant in any scenario, and the capability switch delay of the terminal device may be configured at the combination of the FR granularity and the SCS granularity.

In some embodiments, no data transmission and no data reception are performed between the terminal device and the network device within the duration that starts from the first time and ends at the effect time or the expiry time of the first capability. In other words, the terminal device does not receive and/or does not send data within the duration that starts from the first time and ends at the effect time or the expiry time of the first capability, and the network device does not send data to the terminal device within the duration, thereby avoiding inconsistence between the configuration of the effect time or the expiry time in the terminal device and the configuration of the effect time or the expiry time in the network device and accordingly avoiding low resource utilization. For example, the terminal device is not allowed to receive data via a physical downlink shared channel (PDSCH)/physical downlink control channel (PDCCH) within the duration that starts from the first time and ends at the effect time or the expiry time of the first capability, and the terminal device is not allowed to send data via a physical uplink shared channel (PUSCH) within the duration that starts from the first time and ends at the effect time or the expiry time of the first capability. Taking that the first time is a time corresponding to the last slot n bearing the response message for the first message as an example, the terminal device may not receive and/or not send data within a duration of the first delay after the slot n. Taking that the first time is a time corresponding to the last slot m of the preset duration as an example, the terminal device may not receive and/or not send data within the duration of the first delay after the slot m.

In some embodiments, the terminal device may temporarily receive and/or send data by using a relatively weak capability supported by the terminal device (e.g., the capability of using one receiver antenna to receive data and using one transmit antenna to send data) within the duration that starts from the first time and ends at the effect time or the expiry time of the first capability to ensure that data transmission is not interrupted, thereby improving user experience. Taking that the first capability is the number of receive antennas of the terminal device and the number of transmit antennas of the terminal device as an example, in the case where the maximum number of receive antennas supported by the terminal device and the maximum number of transmit antennas supported by the terminal device are both four, within the duration that starts from the first time and ends at the effect time or the expiry time of the first capability, data transmission and data reception can be performed between the terminal device and the network device by using one transmit antenna and one receiver antenna.

In some embodiments, the first rule may be pre-configured or predefined in the protocol. The terminal device may calculate the effect time or the expiry time of the first capability according to content predefined in the protocol. For example, the first rule predefined in the protocol may indicate that the starting time of the first capability is the first time and the first capability takes effect or expires after the first delay.

In some other embodiments, the first rule may be explicitly configured via signalling. In other words, the effect time corresponding to the first rule or the expiry time corresponding to the first rule is configured via configuration information by the network device. For example, the network device may configure the effect time of the first capability or the expiry time of the first capability via high-layer signalling (e.g., RRC signalling). At the effect time configured via the configuration information or at the expiry time configured via the configuration information, data transmission and data reception can be performed between the terminal device and the network device by using the first capability that is updated via negotiation.

In some embodiments, the configuration information may be contained in the response message for the first message.

In some embodiments, the configuration information may indicate the effect time or the expiry time of the first capability. The indication information for the configuration information is not limited in embodiments of the present disclosure. Exemplarily, the configuration information may include a coordinated universal time (UTC), or include a frame number, or include the frame number and a sub-frame number, or include the frame number and a slot number, or include the frame number, the slot number, and a symbol number in a slot.

In an example, the effect time or the expiry time of the first capability in the configuration information may be expressed as a UTC, where the UTC may contain configurations including year, month, day, hour, minute, second, etc. For example, the effect time or the expiry time of the first capability in the configuration information may be expressed as 2021 Nov. 18 16:00:00. In another example, the effect time or the expiry time of the first capability in the configuration information may be expressed as a frame number and a slot number, e.g., the effect time or the expiry time of the first capability in the configuration information may be expressed as frame 4 and slot 5.

In some embodiments, no data transmission and no data reception are performed between the terminal device and the network device within the duration that starts from the time at which the response message for the first message is received by the terminal device and ends at the effect time or the expiry time of the first capability, where the response message for the first message contains the configuration information. In other words, the terminal device does not receive and/or does not send data within the duration that starts from the time at which the response message for the first message is received by the terminal device and ends at the effect time or the expiry time of the first capability, or the network device does not send data to the terminal device within the duration that starts from the time at which the response message for the first message is sent by the network device and ends at the effect time or the expiry time of the first capability, where the response message for the first message contains the configuration information, thereby avoiding the inconsistence between the configuration of the effect time or the expiry time in the terminal device and the configuration of the effect time or the expiry time in the network device and accordingly avoiding low resource utilization. For example, the terminal device is not allowed to receive data via a PDSCH/PDCCH before the effect time configured via the configuration information, and the terminal device is not allowed to send data via a PUSCH before the effect time configured via the configuration information.

In some embodiments, the terminal device may temporarily receive and/or send data by using a relatively weak capability supported by the terminal device within the duration that starts from the time at which the response message for the first message is received by the terminal device and ends at the effect time or the expiry time of the first capability, where the response message for the first message contains the configuration information, so that it can be ensured that the data transmission is not interrupted, thereby improving user experience. Taking that the first capability is the number of receive antennas of the terminal device and the number of transmit antennas of the terminal device as an example, in the case where the maximum number of receive antennas supported by the terminal device and the maximum number of transmit antennas supported by the terminal device are both four, within the duration that starts from the first time and ends at the effect time or the expiry time of the first capability, data transmission and data reception can be performed between the terminal device and the network device by using one transmit antenna and one receiver antenna.

In some embodiments, capability information of the first capability may include at least one of: the number of transmit antennas of the terminal device, the number of receive antennas of the terminal device, the maximum number of carriers supported by the terminal device, a maximum bandwidth supported by the terminal device, a DC capability of the terminal device, a CA capability of the terminal device, the maximum number of multiple input multiple output layers supported by the terminal device, or a maximum transmit power supported by the terminal device. For example, the capability information of the first capability may include the number of transmit antennas of the terminal device and the number of receive antennas of the terminal device; alternatively, the capability information of the first capability may include the maximum transmit power supported by the terminal device.

In some embodiments, the terminal device may report a capability indication message to the network device. The capability indication message may indicate one or more capabilities of the terminal device. Exemplarily, the capability indication message may indicate at least one of: whether the terminal device supports a capability negotiation function, whether the terminal device supports a function of cancelling a negotiated capability, whether the terminal device supports a function of requesting suspension of DC cell connection or supports a function of requesting release of the DC cell connection, or whether the terminal device supports a function of requesting suspension of CA cell connection or a function of requesting release of the CA cell connection.

In some embodiments, the terminal device may be a single-card terminal device. In some other embodiments, the terminal device may be a multi-card terminal device, i.e., the terminal device has at least two communication cards, e.g., two communication cards, three communication cards, or the like.

Taking that the multi-card terminal device has two communication cards as an example, the two communication cards may be in a connected state at the same time, or when one of the communication cards is in a connected state, the other communication card may be in an idle state or an inactive state. The case that the multi-card terminal device has three or more communication cards is similar to the case that the multi-card terminal device has two communication cards, which is not repeated here.

The method embodiments of the present disclosure are illustrated in detail above with reference to FIG. 1 to FIG. 3. Device embodiments of the present disclosure will be illustrated in detail below with reference to FIG. 4 to FIG. 6. It is understood that the illustration for the method embodiments corresponds to the illustration for the device embodiments, so that for parts that are not illustrated in detail, reference can be made to the preceding method embodiments.

FIG. 4 is a schematic structural diagram of a terminal device provided by embodiments of the present disclosure. A terminal device 400 illustrated in FIG. 4 may include a sending unit 410 and a determining unit 420.

The sending unit 410 is configured to send a first message to a network device, where the first message is used for negotiation of a first capability of a terminal device, and the first capability is associated with a first rule.

The determining unit 420 is configured to determine an effect time or an expiry time of the first capability based on the first rule.

Optionally, the first rule indicates that the first capability comes into effect after a first delay that starts from a first time or expires after the first delay.

Optionally, the terminal device 400 further includes a receiving unit. The receiving unit is configured to receive a response message for the first message sent by the network device. The first time is determined based on a time at which the terminal device receives the response message for the first message.

Optionally, the case that the first time is determined based on the time at which the terminal device receives the response message for the first message includes that: the first time is a time corresponding to a last slot bearing the response message for the first message, the first time is a time corresponding to a last sub-frame bearing the response message for the first message, or the first time is a time corresponding to a last symbol bearing the response message for the first message.

Optionally, the first time is determined based on a time at which the terminal device sends the first message.

Optionally, the case that the first time is determined based on the time at which the terminal device sends the first message includes that: in the case that the terminal device does not receive, within a preset duration after the first message is sent, the response message for the first message sent by the network device, the first time is determined based on the preset duration.

Optionally, the case that the first time is determined based on the preset duration includes that: the first time is a time corresponding to a last slot of the preset duration, the first time is a time corresponding to a last sub-frame of the preset duration, or the first time is a time corresponding to a last symbol of the preset duration; or the first time is a time corresponding to a first slot after an end of the preset duration, the first time is a time corresponding to a first sub-frame after the end of the preset duration, or the first time is a time corresponding to a first symbol after the end of the preset duration.

Optionally, the preset duration is configured via at least one of: a pre-configuration manner, a system broadcast message, or dedicated signalling.

Optionally, the first delay includes at least one of an RRC message process delay, a fixed delay, or a capability switch delay of the terminal device.

Optionally, at least one delay included in the first delay is configured at any one of a FR granularity, a SCS granularity, a combination of the FR granularity and the SCS granularity, and a fixed constant.

Optionally, the terminal device does not receive and/or send data within a duration that starts from the first time and ends at the effect time or the expiry time of the first capability.

Optionally, the effect time corresponding to the first rule or the expiry time corresponding to the first rule is configured via configuration information by the network device.

Optionally, the terminal device 400 further includes a receiving unit. The receiving unit is configured to receive the response message for the first message sent by the network device, where the configuration information is contained in the response message for the first message.

Optionally, the configuration information includes a UTC, or includes a frame number, or includes the frame number and a sub-frame number, or includes the frame number and a slot number, or includes the frame number, the slot number, and a symbol number in a slot.

Optionally, the terminal device does not receive and/or send data within a duration that starts from the time at which the response message for the first message is received by the terminal device and ends at the effect time or the expiry time of the first capability, where the response message for the first message contains the configuration information.

Optionally, the response message for the first message is any one of: an RRC message, a RLC PDU message, a MAC CE message, and a DCI message.

Optionally, capability information of the first capability includes at least one of: the number of transmit antennas of the terminal device, the number of receive antennas of the terminal device, a maximum number of carriers supported by the terminal device, a maximum bandwidth supported by the terminal device, a DC capability of the terminal device, a CA capability of the terminal device, a maximum number of MIMO layers supported by the terminal device, or a maximum transmit power supported by the terminal device.

Optionally, the terminal device 400 further includes a reporting unit. The reporting unit is configured to report a capability indication message to the network device, where the capability indication message indicates at least one of: whether the terminal device supports a capability negotiation function, whether the terminal device supports a function of cancelling a negotiated capability, whether the terminal device supports a function of requesting suspension of DC cell connection or supports a function of requesting release of the DC cell connection, or whether the terminal device supports a function of requesting suspension of CA cell connection or a function of requesting release of the CA cell connection.

The terminal device 400 illustrated in FIG. 4 may be configured to implement the method for wireless communication illustrated in FIG. 2 and FIG. 3, where the implementation is the same as the related implementation of the method illustrated above, and reference can be made to embodiments illustrated in FIG. 2 and FIG. 3, which will not be repeated here.

FIG. 5 is a schematic structural diagram of a network device provided by embodiments of the present disclosure. A network device 500 illustrated in FIG. 5 may include a first receiving unit 510 and a determining unit 520.

The first receiving unit 510 is configured to receive a first message sent by a terminal device, where the first message is used for negotiation of a first capability of the terminal device, and the first capability is associated with a first rule.

The determining unit 520 is configured to determine an effect time or an expiry time of the first capability based on the first rule.

Optionally, the first rule indicates that the first capability comes into effect after a first delay that starts from a first time or expires after the first delay.

Optionally, the network device 500 further includes a sending unit. The sending unit may be configured to send a response message for the first message to the terminal device, where the first time is determined based on a time at which the network device sends the response message for the first message.

Optionally, the case that the first time is determined based on the time at which the network device sends the response message for the first message includes that: the first time is a time corresponding to a first slot bearing the response message for the first message, the first time is a time corresponding to a first sub-frame bearing the response message for the first message, or the first time is a time corresponding to a first symbol bearing the response message for the first message.

Optionally, the first time is determined based on a time at which the network device receives the first message.

Optionally, the case that the first time is determined based on the time at which the network device receives the first message includes that: in the case that the network device does not send, within a preset duration after the network device receives the first message sent by the terminal device, the response message for the first message to the terminal device, the first time is determined based on the preset duration.

Optionally, the case that the first time is determined based on the preset duration includes that: the first time is a time corresponding to a last slot of the preset duration, the first time is a time corresponding to a last sub-frame of the preset duration, or the first time is a time corresponding to a last symbol of the preset duration; or the first time is a time corresponding to a first slot after an end of the preset duration, the first time is a time corresponding to a first sub-frame after the end of the preset duration, or the first time is a time corresponding to a first symbol after the end of the preset duration.

Optionally, the preset duration is configured via at least one of a pre-configuration manner, a system broadcast message, or dedicated signalling.

Optionally, the first delay includes at least one of: an RRC message process delay, a fixed delay, or a capability switch delay of the terminal device.

Optionally, at least one delay included in the first delay is configured at any one of a FR granularity, a SCS granularity, a combination of the FR granularity and the SCS granularity, and a fixed constant.

Optionally, the network device does not receive and/or send data within a duration that starts from the first time and ends at the effect time or the expiry time of the first capability.

Optionally, the effect time corresponding to the first rule or the expiry time corresponding to the first rule is configured via configuration information by the network device.

Optionally, the network device 500 further includes a sending unit. The sending unit may be configured to send the response message for the first message to the terminal device, where the configuration information is contained in the response message for the first message.

Optionally, the configuration information includes a UTC, or includes a frame number, or includes the frame number and a sub-frame number, or includes the frame number and a slot number, or includes the frame number, the slot number, and a symbol number in a slot.

Optionally, the network device does not receive and/or send data within a duration that starts from the time at which the response message for the first message is sent by the network device and ends at the effect time or the expiry time of the first capability, where the response message for the first message contains the configuration information.

Optionally, a response message for the first message is any one of: an RRC message, an RLC PDU message, a MAC CE message, and a DCI message.

Optionally, capability information of the first capability includes at least one of: the number of transmit antennas of the terminal device, the number of receive antennas of the terminal device, a maximum number of carriers supported by the terminal device, a maximum bandwidth supported by the terminal device, a DC capability of the terminal device, a CA capability of the terminal device, a maximum number of MIMO layers supported by the terminal device, or a maximum transmit power supported by the terminal device.

Optionally, the network device 500 further includes a second receiving unit. The second receiving unit may be configured to receive a capability indication message reported by the terminal device, where the capability indication message indicates at least one of: whether the terminal device supports a capability negotiation function, whether the terminal device supports a function of cancelling a negotiated capability, whether the terminal device supports a function of requesting suspension of DC cell connection or supports a function of requesting release of the DC cell connection, or whether the terminal device supports a function of requesting suspension of CA cell connection or a function of requesting release of the CA cell connection.

The network device 500 illustrated in FIG. 5 may be configured to implement the method for wireless communication illustrated in FIG. 2 and FIG. 3, where the implementation is the same as the related implementation of the method illustrated above, and reference can be made to embodiments illustrated in FIG. 2 and FIG. 3, which will not be repeated here.

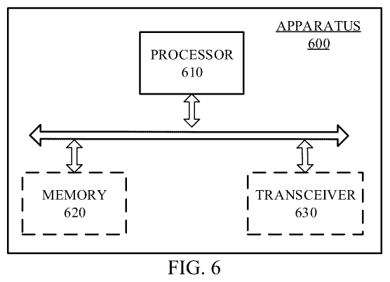

FIG. 6 is a schematic structural diagram of a communication apparatus of embodiments of the present disclosure. The line of dashes in FIG. 6 indicates that the unit or module is optional. The apparatus 600 may be configured to implement the method illustrated in the above method embodiments, where the implementation is the same as the related implementation of the method illustrated above, and reference can be made to embodiments illustrated in FIG. 2 and FIG. 3, which will not be repeated here. The apparatus 600 may be a chip, a terminal device, or a network device.

The apparatus 600 may include one or more processors 610. A processor 610 may support the apparatus 600 to implement the method embodiments described above. The processor 610 may be a general-purpose processor or a dedicated processor. For example, the processor may be a central processing unit (CPU) or may be other general purpose processors, a digital signal processor (DSP), an application specific integrated circuit (ASIC), a field programmable gate array (FPGA), or another programmable logic device, a discrete gate or a transistor logic device, a discrete hardware component, etc. The general purpose processor may be a microprocessor, or the processor may be any conventional processor or the like.

The apparatus 600 may further include one or more memories 620. The memory 620 is configured to store program codes to enable the processor 610 to perform the methods illustrated in the foregoing method embodiments. The memory 620 may be independent of the processor 610 or may be integrated into the processor 610.

The apparatus 600 may further include a transceiver 630. The processor 610 may communicate with other devices or chips via the transceiver 630. For example, the processor 610 may send data to other devices or chips and receive data from other devices or chips via the transceiver 630.

Embodiments of the present disclosure further provide a computer-readable storage medium configured to store a program. The computer-readable storage medium may be applied in a terminal or a network device provided in embodiments of the present disclosure. The program causes a computer to perform a method performed by a terminal or a network device in respective embodiments of the present disclosure.

Embodiments of the present disclosure further provide a computer program product. The computer program product includes a program. The computer program product may be applied in a terminal or a network device provided by embodiments of the present disclosure. The program causes a computer to perform a method performed by a terminal or a network device in respective embodiments of the present disclosure.

Embodiments of the present disclosure further provide a computer program. The computer program may be applied in a terminal or a network device provided by embodiments of the present disclosure, and the computer program causes a computer to perform a method performed by a terminal or a network device in respective embodiments of the present disclosure.

It is understood that the terms “system” and “network” in this disclosure can be used interchangeably. Terms used in the present disclosure are merely intended for explaining embodiments of the disclosure rather than limiting the disclosure. The terms “first”, “second”, “third”, “fourth”, and the like used in the specification, the claims, and the accompanying drawings of the disclosure are used to distinguish different objects rather than describe a particular order. In addition, the terms “include”, “comprise”, and “have” as well as variations thereof are intended to cover a non-exclusive inclusion.

It should be understood that “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that there is an association relationship between A and B.

In embodiments of the disclosure, “B corresponding to A” means that B is associated with A, and B can be determined according to A. However, it is further understood that “determine B according to A” does not mean that B is determined according to A only, and B may also be determined according to A and/or other information.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In embodiments of the disclosure, the “pre-defined” or “pre-configured” can be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

The term “and/or” referred to in embodiments of the disclosure only describes an association relationship between associated objects, which means that there can be three relationships. For example, A and/or B can mean A alone, both A and B exist, and B alone. In addition, the character “/” herein generally indicates that the associated objects are in an “or” relationship.

In various embodiments of the disclosure, the magnitude of a sequence number of each of the foregoing processes does not imply an execution order, and the execution order between the processes should be determined according to function and internal logic thereof, which shall not constitute any limitation to the implementation of embodiments of the disclosure.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve the desired objectives of the disclosure.

In addition, various functional units described in various embodiments of the disclosure may be integrated into one processing unit or may be present as a number of physically separated units, and two or more units may be integrated into one.

All or some of the above embodiments can be implemented through software, hardware, firmware, or any other combination thereof. When implemented by software, all or some of the above embodiments can be implemented in the form of a computer program product. The computer program product includes one or more computer instructions. When the computer instructions are applied and executed on a computer, all or some of the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

The foregoing elaborations are merely implementations of the disclosure but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A method for wireless communication, comprising:
sending, by a terminal device, a first message to a network device, wherein the first message is used for negotiation of a first capability of the terminal device, and the first capability is associated with a first rule; and
determining, by the terminal device, an effect time or an expiry time of the first capability based on the first rule.

2. The method of claim 1, wherein the first rule indicates that the first capability comes into effect after a first delay that starts from a first time or expires after the first delay.

3. The method of claim 2, wherein the first time is determined based on a time at which the terminal device sends the first message.

4. The method of claim 3, wherein the case that the first time is determined based on the time at which the terminal device sends the first message comprises that: in the case that the terminal device does not receive, within a preset duration after the first message is sent, a response message for the first message sent by the network device, the first time is determined based on the preset duration.

5. The method of claim 4, wherein the case that the first time is determined based on the preset duration comprises that: the first time is a time corresponding to a last slot of the preset duration, the first time is a time corresponding to a last sub-frame of the preset duration, or the first time is a time corresponding to a last symbol of the preset duration; or the first time is a time corresponding to a first slot after an end of the preset duration, the first time is a time corresponding to a first sub-frame after the end of the preset duration, or the first time is a time corresponding to a first symbol after the end of the preset duration.

6. The method of claim 4, wherein the preset duration is configured via at least one of a pre-configuration manner, a system broadcast message, or dedicated signalling.

7. The method of claim 2, wherein the first delay comprises at least one of a radio resource control (RRC) message process delay, a fixed delay, or a capability switch delay of the terminal device.

8. The method of claim 1, wherein a response message for the first message is any one of:
an RRC message;
a radio link control (RLC) protocol data unit (PDU) message;
a medium access control (MAC) control element (CE) message; and
a downlink control information (DCI) message.

9. The method of claim 1, wherein capability information of the first capability comprises at least one of:
a number of transmit antennas of the terminal device;
a number of receive antennas of the terminal device;
a maximum number of carriers supported by the terminal device;
a maximum bandwidth supported by the terminal device;
a dual-connectivity (DC) capability of the terminal device;
a carrier aggregation (CA) capability of the terminal device;
a maximum number of multiple input multiple output (MIMO) layers supported by the terminal device; or
a maximum transmit power supported by the terminal device.

10. The method of claim 1, further comprising:
reporting, by the terminal device, a capability indication message to the network device, wherein the capability indication message indicates at least one of:
whether the terminal device supports a capability negotiation function;
whether the terminal device supports a function of cancelling a negotiated capability;
whether the terminal device supports a function of requesting suspension of DC cell connection or supports a function of requesting release of the DC cell connection; or
whether the terminal device supports a function of requesting suspension of carrier aggregation (CA) cell connection or a function of requesting release of the CA cell connection.

11. A terminal device, comprising:
a transceiver;
a processor coupled to the transceiver; and
a memory storing a computer program which, when executed by the processor, causes the terminal device to:
send a first message to a network device, wherein the first message is used for negotiation of a first capability of the terminal device, and the first capability is associated with a first rule; and
determine an effect time or an expiry time of the first capability based on the first rule.

12. The terminal device of claim 11, wherein the first rule indicates that the first capability comes into effect after a first delay that starts from a first time or expires after the first delay.

13. The terminal device of claim 12, wherein the first time is determined based on a time at which the terminal device sends the first message.

14. A network device, comprising:
a transceiver;
a processor coupled to the transceiver; and
a memory storing a computer program which, when executed by the processor, causes the network device to:
receive a first message sent by a terminal device, wherein the first message is used for negotiation of a first capability of the terminal device, and the first capability is associated with a first rule; and
determine an effect time or an expiry time of the first capability based on the first rule.

15. The network device of claim 14, wherein the first rule indicates that the first capability comes into effect after a first delay that starts from a first time or expires after the first delay.

16. The network device of claim 15, wherein the first time is determined based on a time at which the network device receives the first message.

17. The network device of claim 16, wherein the case that the first time is determined based on the time at which the network device receives the first message comprises that: in the case that the network device does not send, within a preset duration after the network device receives the first message sent by the terminal device, a response message for the first message to the terminal device, the first time is determined based on the preset duration.

18. The network device of claim 17, wherein the case that the first time is determined based on the preset duration comprises that: the first time is a time corresponding to a last slot of the preset duration, the first time is a time corresponding to a last sub-frame of the preset duration, or the first time is a time corresponding to a last symbol of the preset duration; or the first time is a time corresponding to a first slot after an end of the preset duration, the first time is a time corresponding to a first sub-frame after the end of the preset duration, or the first time is a time corresponding to a first symbol after the end of the preset duration.

19. The network device of claim 17, wherein the preset duration is configured via at least one of a pre-configuration manner, a system broadcast message, or dedicated signalling.

20. The network device of claim 15, wherein the first delay comprises at least one of a radio resource control (RRC) message process delay, a fixed delay, or a capability switch delay of the terminal device.
